(19) United States
(12) Patent Application Publication
(10) Pub. No.: US 2004/0233383 A1
(43) Pub. Date: Nov. 25, 2004

(54) Artificial iris and lens apparatus

(76) Inventors: Richard H. Sandler, Evanston, IL (US); Hansen A. Mansy, Justice, IL (US)

Correspondence Address: GROSSMAN & FLIGHT, LLC, 20 N. WACKER DRIVE, SUITE 4220, CHICAGO, IL, 60606, US

(21) Appl. No.: 10/736,716

(22) Filed: Dec. 16, 2003

Related U.S. Application Data
(60) Provisional application No. 60/433,698, filed on Dec. 16, 2002.

(51) Int. Cl. G02C 7/10

(52) U.S. Cl. 351/163

(57) ABSTRACT

Artificial iris and lens apparatus are disclosed. An example apparatus includes a lens-shaped body having first and second regions. The second region has a lower light transmission characteristic than the first region and at least a portion of the second region is configured to reduce a retinal distortion.

### RELATED APPLICATION

This application claims the benefit of the filing date of provisional U.S. Patent Application No. 60/433,698 filed on Dec. 16, 2002.

### FIELD OF THE DISCLOSURE

The present invention relates generally to artificial ocular devices and, more specifically, to artificial iris and lens apparatus.

### BACKGROUND

The iris portion of an eye may be damaged as a result of trauma or disease. Once damaged, the iris may fail to adequately perform its function of varying the amount of light admitted to the retina in response to changing ambient light conditions. The failure of an iris to properly control the amount of light impinging on the retina can result in blurred or otherwise poor vision that is often accompanied by substantial patient discomfort and dysfunction. In some cases, the iris may be damaged in a localized region and may remain somewhat responsive to ambient light. However, the damaged region of the iris may nevertheless result in a distorted retinal image, patient discomfort, patient dysfunction, etc.

Likewise, damage to the cornea, lens and other portions of an eye can result in poor optical transmission characteristics that distort the image on the retina and, thus, the image perceived by the subject. For example, cornea irregularities due to, for example, trauma, congenital lesions, infections, and laser surgery can substantially distort the retinal image. Similarly, lens lesions due to, for example, cataracts, cicatrix, trauma, congenital lesions, infections and other diseases can also cause optical transmission irregularities that distort the retinal image. Still further, aqueous humor lesions may also cause distorted or poor retinal imaging.

A damaged lens portion of an eye may be surgically removed and replaced with an artificial lens. Unfortunately, such artificial lenses are passive structures that do not vary their optical characteristics to change the focal length of the eye in a manner similar to that of a real lens.

### BRIEF DESCRIPTION OF THE DRAWINGS

FIG. 1 is a plan view of an example of an artificial iris;

FIG. 2 is a cross-sectional view of the example artificial iris shown in FIG. 1;

FIG. 3 is a plan view of another example of an artificial iris;

FIG. 4 is a plan view of yet another example of an artificial iris;

FIG. 5 is a plan view of still another example of an artificial iris;

FIG. 6 is a plan view of an example of an electronically controllable artificial iris;

FIG. 7 is a plan view of an example of an electronically controllable artificial lens; and

FIG. 8 is a cross-sectional view of the electronically controllable artificial lens shown in FIG. 7.

### DETAILED DESCRIPTION

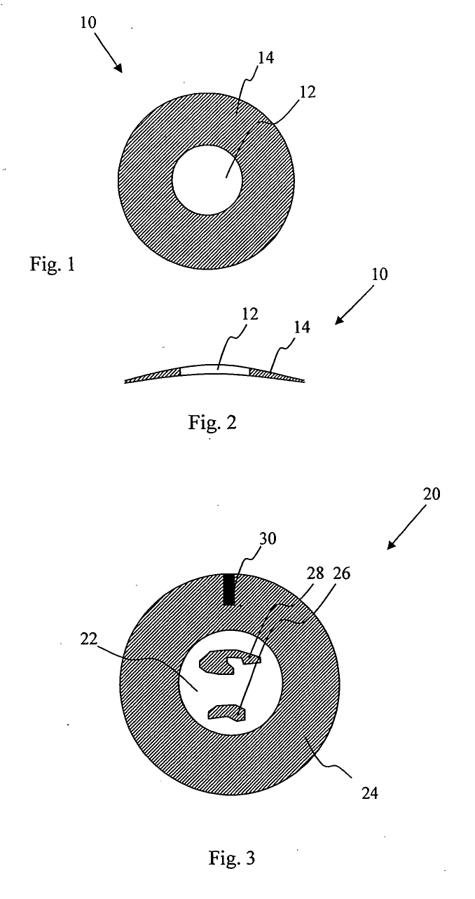

FIG. 1 is a plan view of an example of an artificial iris 10 and FIG. 2 is a cross sectional view of the iris 10 shown in FIG. 1. As depicted in FIGS. 1 and 2, the artificial iris 10 may be formed as a lens-shaped device that that may be placed on the surface (e.g., the cornea) of an eye, in manner similar to that of a contact lens, and worn by a subject for an extended period of time.

The example artificial iris 10 shown in FIGS. 1 and 2 includes a central clear region 12 that has a relatively high light transmission characteristic and a masked region 14 that is opaque or which has a relatively low light transmission characteristic. The masked region 14 is preferably configured to mask those portions of the subject's eye (e.g., the iris, cornea, lens, etc.) that would otherwise contribute to a distortion of the retinal image produced by the eye. In this manner, the artificial iris 10 effectively limits functional pupil diameter to limit the amount of light impinging on the retina and/or to prevent light traveling through eye tissue having sub-optimal light transmission characteristics (e.g., damaged eye tissue) from contributing distortion to the retinal image.

The masked region 14 of the example artificial iris 10 shown in FIGS. 1 and 2 is static or fixed, concentric and symmetric with respect to the clear central region 12. However, the geometries of the central region 12 and the masked region 14 may be varied to suit the needs of a particular subject and/or the light ambient conditions surrounding a subject or subjects. For example, a particular subject may be provided with several sets of artificial irises such as those shown in FIGS. 1 and 2. Each set of artificial irises may be configured to mask portion(s) of the subject's eyes that would contribute to a distorted image and/or to provide a particular functional pupil diameter suitable for a particular range of ambient light levels. For example, the masked region 14 provided with one set of artificial irises may yield a relatively large functional pupil diameter (while still masking the sub-optimal or damaged eye tissue) that is suitable for relatively low ambient light conditions (i.e., relatively dark conditions). Whereas, the masked region 14 provided with another set of artificial irises may yield a relatively small functional pupil diameter suitable for relatively high ambient light conditions (i.e., relatively bright conditions). Thus, a subject may selectively wear the set of artificial irises appropriate for the ambient light conditions.

The artificial iris 10 shown in FIGS. 1 and 2 may be made from the same materials or materials that are used for disposable contact lenses. In addition, the masked region 14 may be implemented using a component that is integrally molded with the artificial iris 10. Alternatively, the masked region 14 may be implemented by dying, inking, or otherwise altering the material of the iris 10 to reduce the light transmission characteristics or properties of the masked region 14.

Preferably the artificial iris 10 is customized to meet the individual needs of a particular subject. Additionally or alternatively, the artificial iris could be pre-manufactured in a range of configurations to suit a range of eye geometries, eye irregularities, ambient light conditions, etc.

FIG. 3 is a plan view of another example of an artificial iris 20. The artificial iris 20 is a lens-shaped device that is similar to the artificial iris shown in FIGS. 1 and 2. As depicted in FIG. 3, the artificial iris 20 has a clear central region 22 having a relatively high light transmission characteristic and a peripheral masked region 24 having a relatively low light transmission characteristic (e.g., opaque).

In contrast to the artificial iris 10 shown in FIGS. 1 and 2, the artificial iris 20 includes one or more masked regions 26 and 28 that are separate from the peripheral masked region 24. The masked regions 26 and 28 are preferably, but not necessarily, disposed in areas of the central region 22 that correspond to damaged or otherwise sub-optimal eye tissue, which may be associated with the cornea and/or lens of the eye with which the artificial iris 20 is to be used. While the geometry of the masked regions 26 and 28 are depicted as being irregular, other regular geometries such as, for example, circular, polygonal, etc. could be used instead.

Still further, an index or alignment mark 30 may be provided to facilitate alignment of the artificial iris 20 with the subject's eye. In this manner, the alignment mark 30 may be used to more quickly and precisely align the masked regions 26 and 28 with the underlying sub-optimal tissue of the eye for which the artificial iris 20 was designed.

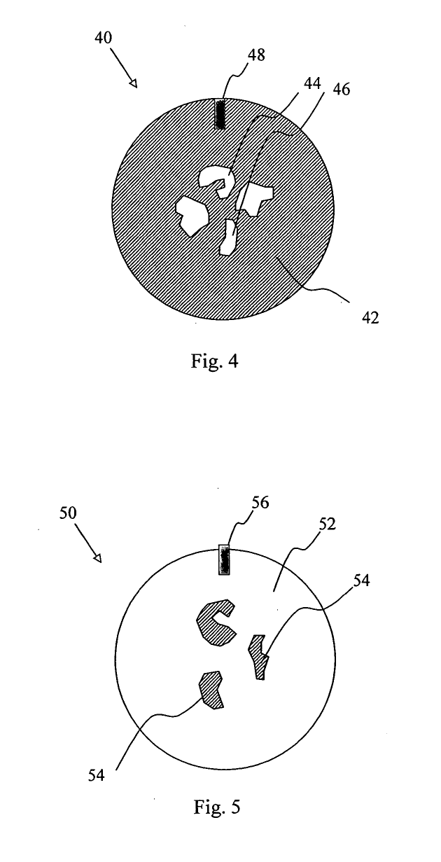

FIG. 4 is a plan view of yet another example of an artificial iris 40. As depicted in FIG. 4, the artificial iris 40 includes a masked region 42 and one or more relatively clear regions 44 and 46 that correspond to selected portions of a subject's eye that are suitable for producing a retinal image. Depending on the characteristics of the subject's eye, the geometry of the clear regions 44 and 46 may be irregular as depicted or, if desired, may be formed using a regular geometry such as, for example, circular, polygonal, etc. The artificial iris 40 may also include an alignment mark or indicator 48.

FIG. 5 is a plan view of still another example of an artificial iris 50. The artificial iris shown in FIG. 5 includes a relatively clear region 52 and one or more masked regions 54 that correspond to portions of a subject's eye having sub-optimal light transmission characteristics. The artificial iris 50 may also include an alignment mark 56.

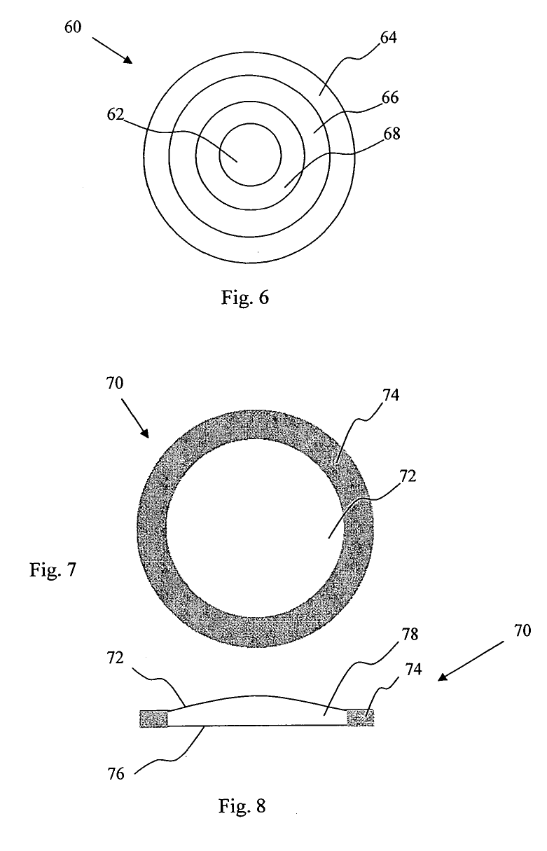

FIG. 6 is a plan view of an example electronically controllable artificial iris 60. The artificial iris 60 includes a central relatively clear region 62 that is surrounded by a plurality of maskable regions 64, 66 and 68. The maskable regions 64-68 may be implemented using a liquid crystal display technology or the like that enables the light transmission properties of the maskable regions 64-68 to be individually varied in response an electrical signal or signals.

Thus, the maskable regions 64-68 may be controlled to vary the effective diameter of the central clear region 62 in response to changes in ambient light conditions. For example, in relatively low (i.e., dark) ambient light conditions, one or more of the maskable regions 64-68 may be electronically controlled to be relatively clear, thereby increasing the effective diameter of the relatively clear central region 62 and allowing more light to pass through the artificial iris 60 to the retina. On the other hand, in relatively high (i.e., bright) ambient light conditions, all or most of the maskable regions 64-68, for example, may be electronically controlled to be relatively opaque to limit the effective diameter of the central region 62 and to reduce the amount of light impinging on the retina.

While the maskable regions 64-68 are depicted as being symmetric and concentric with respect to the central region 62, other irregular or non-symmetric geometries could be used instead. For example, the electronically controlled maskable regions 64-68 could be similar or identical to the masked regions shown in FIGS. 3-5.

Electronic control of the maskable regions 64-68 may be user-activated and/or may be automatically responsive to changing ambient light conditions. For example, a battery powered processor unit may be worn on the subject's body (e.g., attached to or integral with apparel or an accessory) and may be coupled via wireless communications or signals to the artificial iris 60.

FIG. 7 is a plan view of an example electronically controllable artificial lens 70 and FIG. 8 is a cross-sectional view of the electronically controllable artificial lens 70 shown in FIG. 7. As depicted in FIGS. 7 and 8, the artificial lens 70 includes a relatively flexible surface 72, an actuator ring 74, a relatively rigid surface 76 and a relatively incompressible fluid 78 disposed between the surfaces 72 and 76.

In operation, the focal length of the lens 70 is varied in response to the diametrical expansion and contraction of the actuator ring 74. When the actuator ring 74 contracts diametrically, the relatively flexible surface 72 bulges or move away from the rigid surface 76 to decrease the focal length of the lens 70. On the other hand, when the actuator ring 74 expands diametrically, the relatively flexible surface 72 is drawn toward the relatively rigid surface 76 to increase the focal length of the lens 70. The relatively rigid surface 76 may be implemented using a rigid material and/or by fixing the surface 76 to a cornea or to some other relatively rigid surface. In any case, during expansion and contraction of the actuator ring 74, the relatively rigid surface 76 does not undergo any significant shape change.

In yet another example, the surface 76 may be a flexible membrane that accommodates the expansion and contraction of the actuator ring 74. However, in that case, the surface 76 may be stretched over the actuator ring 74 and/or may be supported by a relatively rigid surface to prevent any significant changes to the curvature of the surface 76.

Alternatively, the surface 76 may be implemented using a flexible material similar or identical to that used for the surface 72. In that case, the surface 76 is free to move (i.e., is not supported or fixed to a relatively rigid surface) and may be configured to change shape in manner that is similar or identical to the surface 72, thereby enhancing the effect of the surface 72 on the focal length of the lens 70.

The actuator ring 74 may be implemented using a piezoelectric material such as, for example, a PZT material that is formed or cast as unitary structure. Additionally or alternatively, the actuator ring 74 may be composed of layered piezoelectric devices and/or may be composed of materials that expand or contract in response to temperature changes. In any case, the actuator ring 74 and, thus, the focal length of the lens 70 may be electronically controlled via an electronic device such as that described above in connection with the electronically controllable iris shown in FIG. 6. However, other sensor inputs such as, for example, infrared, laser, sonar, etc. may be used to provide range information to determine the best focal length for the environment surrounding the subject. Ranging and focusing technologies used in connection with known cameras and other optical equipment could be adapted to enable the lens 70 perform an auto-focus function.

The artificial lens 70 example shown in FIGS. 7 and 8 could be configured for implantation, for use in a manner similar to that of a contact lens, which may or may not be disposable, could be integrated with eyeglasses or otherwise mechanically suspended for use by a subject, etc.

Thus, while the present disclosure provides specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. An apparatus, comprising:
a lens-shaped body including first and second regions, wherein the second region has a lower light transmission characteristic than the first region, and wherein the at least a portion of the second region is configured to reduce a retinal distortion.
